(19) United States
(12) Patent Application Publication
(10) Pub. No.: US 2004/0078700 A1
(43) Pub. Date: Apr. 22, 2004

(54) Apparatus and method for processing defects in memories

(75) Inventor: Jae Seong Jeong, Suwon (KR)

Correspondence Address: LOWE HAUPTMAN GOPSTEIN GILMAN & BERNER, LLP, Suite 310, 1700 Diagonal Road, Alexandria, VA, 22314, US

(73) Assignee: Samsung Electro-Mechanics Co., Ltd.

(21) Appl. No.: 10/319,709

(22) Filed: Dec. 16, 2002

(30) Foreign Application Priority Data
Sep. 12, 2002 (KR) 2002-55269

(51) Int. Cl. G06F 11/00

(52) U.S. Cl. 714/42

(57) ABSTRACT

An apparatus and method for processing defects in a card-type memory unit such as a flash memory card, which can detect a defective location of the memory unit and replace a memory area having the detected defective location with a different memory area, or ignore it. The method comprises the first step of performing a memory function testing operation and collecting results thereof, the second step of providing no-defect information if no defect is determined to be present in the memories on the basis of the collected results, the third step of determining whether a defect-free operation has been performed with respect to a defective block having a defect, if the defect is determined to be present at the second step, the fourth step of performing the defect-free operation with respect to the defective block if it is determined at the third step that the defect-free operation has not been performed, the fifth step of determining whether the defect is serious, if it is determined at the third step that the defect-free operation has been performed, and providing information for replacement of a specific one of the memories having the defective block if the defect is determined not to be serious, and the sixth step of providing information for discarding of a memory card including the memories if the defect is determined to be serious.

### BACKGROUND OF THE INVENTION

1. Field of the Invention

The present invention relates to an apparatus and method for processing defects in memories, and more particularly to an apparatus and method for processing defects in a card-type memory unit such as a f lash memory card, which can detect a defective location of the memory unit and replace a memory area having the detected defective location with a different memory area, or ignore it, so that the memory unit can be used regardless of defects, resulting in an increase in actual yield in a production process, and so that purchasing costs of additional memory cards can be reduced when the memory unit is in use, resulting in reduced frequency of breakdowns and reduced maintenance costs.

2. Description of the Related Art

A flash memory card (FMC), secure digital card (SDC), multi-media card (MMC), smart media card (SMC), and compact flash card (CFC), etc. have generally been proposed as card-type memory units. With the rapid spread of portable digital multimedia equipment such as a digital camera, devices employing such card-type memory units as storage units have rapidly become widespread. In the case where a digital camera is equipped with, for example, an FMC, more particularly an 8 MB flash memory unit, a maximum of 26 VGAs (640×480) or 101 QVGAs (320×240) can be stored in the 8 MB flash memory unit in a JPEG format. The FMC typically includes therein a plurality of memories, and a controller for performing a read/write operation with respect to the memories. These memories are implemented with memory ICs.

However, a defect may occur in a specific block of an arbitrary memory in the FMC due to various factors such as physical shocks experienced in the FMC production process and in use by an ordinary user. In this case, if the defect is not serious, the memory is replaced with a normal one. However, if the defect is serious, the memory card itself is discarded. Here, the defect is defined as the inequality between written contents and read contents or the occurrence of a write or read error when a write or read operation is performed at an arbitrary location (arbitrary block) of a flash memory. A serious defect is defined as the case where all blocks in the flash memory are defective blocks.

FIG. 1 is a block diagram illustrating a used state of a general flash memory card. With reference to FIG. 1, a general flash memory card (FMC) 30 is driven by an FMC driver 20 under control of a computer controller 10. Using this flash memory card, data such as a still image or moving image can be read or written as stated previously.

FIG. 2 is a flow chart illustrating a conventional method for testing for defects in a flash memory card. With reference to FIG. 2, the conventional flash memory card defect testing method comprises step S1 of performing a function testing operation if an FMC test is started, step S2 of performing a formatting operation and read/write operation, step S3 of determining whether there is a defect in each memory block, and steps S4 to S7 of packaging and sending out the flash memory card as a normal product if there is no defect, and, if there is a defect, determining whether the defect is serious, replacing only a flash memory in the card having a defective memory block with a different one if the defect is not serious, and discarding the card itself if the defect is serious.

In the conventional flash memory card defect testing method, as mentioned above, when a defect occurs in a flash memory in the flash memory card during the production process, the flash memory card itself is discarded or the flash memory is replaced with one of good quality. However, the discarding of the FMC itself against the occurrence of a defect reduces productivity. Further, the flash memory replacement necessitates additional costs, resulting in a further degradation in productivity.

Moreover, the occurrence of a defect in a flash memory in the flash memory card in use causes a user to expend additional costs.

For these reasons, the conventional flash memory card defect testing method results in an increase in maintenance costs or purchasing costs of additional FMCs.

### SUMMARY OF THE INVENTION

Therefore, the present invention has been made in view of the above problems, and it is an object of the present invention to provide an apparatus and method for processing defects in a card-type memory unit such as a flash memory card, which can detect a defective location of the memory unit and replace a memory area having the detected defective location with a different memory area, or ignore it.

It is another object of the present invention to provide an apparatus and method for processing defects in a card-type memory unit such as a flash memory card, wherein the memory unit can be used regardless of defects, resulting in an increase in actual yield in a production process, and purchasing costs of additional memory cards can be reduced when the memory unit is in use, resulting in reduced frequency of breakdowns and reduced maintenance costs.

In accordance with one aspect of the present invention, the above and other objects can be accomplished by the provision of an apparatus for processing defects in one or more memories, comprising: a computer controller for controlling an initial memory defect testing operation and a subsequent memory read/write operation; a memory card driver for driving the memories under the control of the computer controller and controlling the memory defect testing operation and memory read/write operation under the control of the computer controller; and a memory card responsive to a test control command from the computer controller, initially applied thereto via the memory card driver, for performing the memory defect testing operation, performing a defect-free operation for a defective block if the defective block is determined to be present as a result of the memory defect testing operation and appending the resulting defect information to a defect information lookup table of one of the memories corresponding to the defective block, and responsive to a read/write control command from the computer controller, subsequently applied thereto via the memory card driver, for performing the read/write operation for the corresponding memory with reference to the defect information of the lookup table.

In accordance with another aspect of the present invention, there is provided an apparatus for processing defects in one or more memories, comprising: a computer controller for controlling an initial memory defect testing operation and a subsequent memory read/write operation; a memory card driver for driving the memories under the control of the computer controller, the memory card driver being operated in response to a test control command from the computer controller, initially applied thereto, to perform the memory defect testing operation, perform a defect-free operation for a defective block if the defective block is determined to be present as a result of the memory defect testing operation and append the resulting defect information to a defect information lookup table of one of the memories corresponding to the defective block, and operated in response to a read/write control command from the computer controller, subsequently applied thereto, to control the read/write operation for the corresponding memory with reference to the defect information of the lookup table; and a memory card driven by the memory card driver, the memory card including the memories and serving to perform the read/write operation for the corresponding memory in response to a read/write control command from the memory card driver.

In accordance with yet another aspect of the present invention, there is provided a method for processing defects in one or more memories, comprising the steps of: a) performing a memory function testing operation and collecting results thereof; b) providing no-defect information if no defect is determined to be present in the memories on the basis of the collected results, and proceeding to a subsequent step if a defect is determined to be present; c) determining whether a defect-free operation has been performed with respect to a defective block having a defect, if the defect is determined to be present at the step b); d) performing the defect-free operation with respect to the defective block if it is determined at the step c) that the defect-free operation has not been performed; e) determining whether the defect is serious, if it is determined at the step c) that the defect-free operation has been performed, and providing information for replacement of a specific one of the memories having the defective block if the defect is determined not to be serious; and f) providing information for discarding of a memory card including the memories if the defect is determined to be serious at the step e).

Preferably, the above memories may be flash memories and the memory card driver may be a flash memory card (FMC) driver.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a block diagram illustrating a used state of a general flash memory card;

FIG. 2 is a flow chart illustrating a conventional method for testing for defects in a flash memory card;

FIG. 3 is a block diagram showing the construction of a memory defect processing apparatus in accordance with a first embodiment of the present invention;

FIGS. 4a and 4b are views showing different examples of settings of storage areas of a memory card in FIG. 3;

FIG. 5 is a view showing an example of a defect information lookup table in FIG. 4a or 4b;

FIGS. 6a and 6b are views showing yet other examples of settings of storage areas of the memory card in FIG. 3;

FIG. 7 is a view showing an example of a defect information lookup table in FIG. 6a or 6b;

FIG. 8 is a block diagram showing the construction of a memory defect processing apparatus in accordance with a second embodiment of the present invention;

FIG. 9 is a flow chart illustrating a memory defect processing method in accordance with a third embodiment of the present invention;

FIG. 10 is a flow chart illustrating an example of a defect-free process in FIG. 9;

FIG. 11 is a flow chart illustrating a memory read/write method corresponding to the defect-free process of FIG. 10;

FIG. 12 is a flow chart illustrating another example of the defect-free process in FIG. 9; and

FIG. 13 is a flow chart illustrating a memory read/write method corresponding to the defect-free process of FIG. 12.

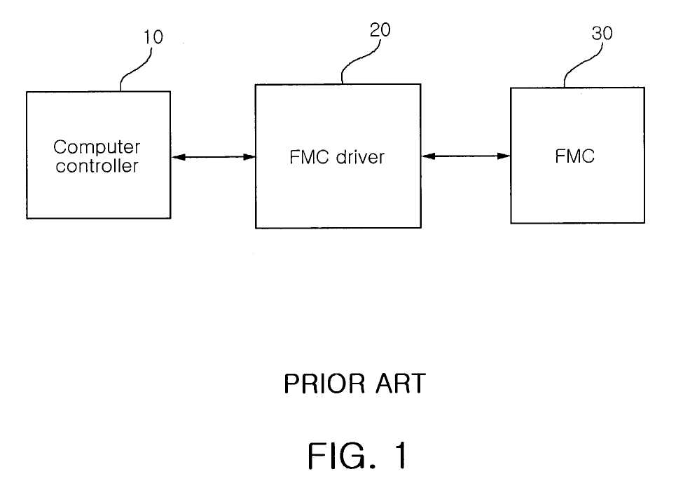

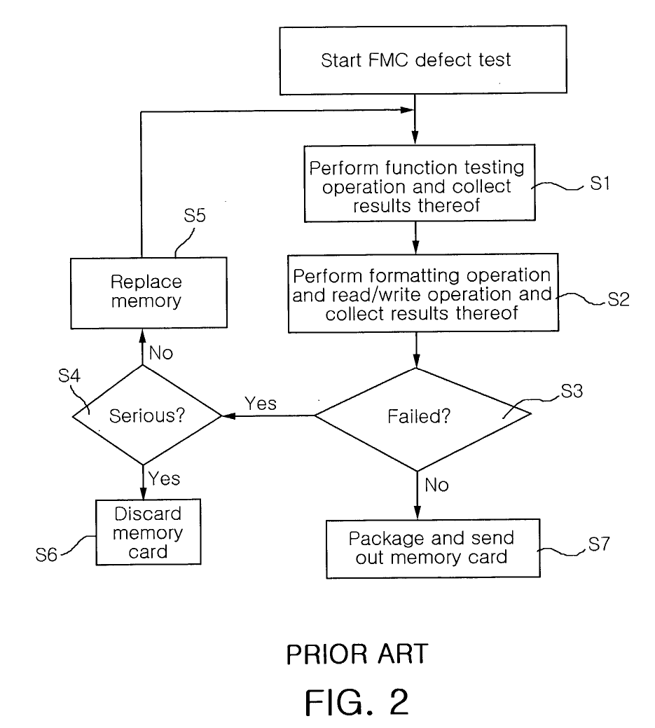

### DESCRIPTION OF THE PREFERRED EMBODIMENTS

Now, the construction and operation of a memory defect processing apparatus in accordance with the present invention will be described in detail with reference to the annexed drawings. In the drawings, constituent elements having substantially the same configurations and functions are denoted by the same reference numerals even though they are depicted in different drawings.

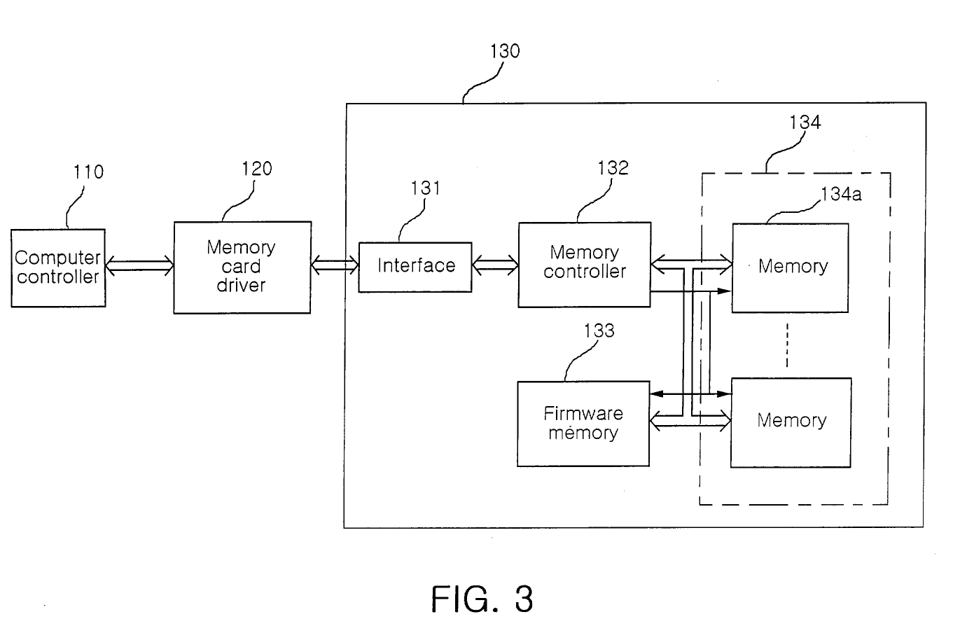

With reference to FIG. 3, there is shown in block form the construction of a memory defect processing apparatus in accordance with a first embodiment of the present invention. As shown in this drawing, the memory defect processing apparatus comprises a computer controller 110 for controlling an initial memory defect testing operation and a subsequent memory read/write operation, a memory card driver 120 for driving one or more memories under the control of the computer controller 110 and controlling the memory defect testing operation and memory read/write operation under the control of the computer controller 110, and a memory card 130 responsive to a test control command from the computer controller 110, initially applied thereto via the memory card driver 120, for performing the memory defect testing operation, performing a defect-free operation for a defective block if the defective block is determined to be present as a result of the memory defect testing operation, and appending the resulting defect information to a defect information lookup table DLT of one of the memories corresponding to the defective block. The memory card 130 is also adapted to perform the read/write operation for the corresponding memory with reference to the defect information of the lookup table DLT in response to a read/write control command from the computer controller 110, subsequently applied thereto via the memory card driver 120.

In the first embodiment of the present invention, in the case where the memories are flash memories, the memory card driver is a flash memory card (FMC) driver. In this case, the memory defect processing apparatus in accordance with the first embodiment of the present invention is adapted to process defects in flash memories. Here, the memories signify semiconductor-based storage units. Although the present invention is not limited to being applicable to only specific memories, it has been implemented to be most suitable to flash memories. This is similarly applied to different embodiments of the present invention.

Also, in the present invention, the block can be defined as different terms according to applied memories. Here, the block signifies a basic processing unit of a memory when data is read or written from/into the memory.

The memory card 130 includes an interface 131 connected to the memory card driver 120, and a memory controller 132 for receiving the test control command from the computer controller 110 via the interface 131, performing the memory defect testing operation in response to the received test control command, performing the defect-free operation for a defective block if the defective block is determined to be present as a result of the memory defect testing operation, appending the resulting defect information to a defect information lookup table of one of the memories corresponding to the defective block, receiving the read/write control command from the computer controller 110 via the interface 131 and controlling the read/write operation for the corresponding memory with reference to the defect information of the lookup table. The above memories are one or more data memories 134 which are provided in the memory card 130 to store data under the control of the memory controller 132. A firmware memory 133 is further provided in the memory card 130 to store firmware necessary to the operation of the memory controller 132.

The memory controller 132 can perform the defect-free operation in various manners according to different software implementations. As two representative manners among them, the first is to replace a defective block with a replacement block and the second is to ignore a defective block.

First, in order to perform the first defect-free process, the memory controller 132 can be configured in the below manner.

The memory controller 132 is configured to write and read test information into/from each of the data memories, recognize an address of a defective block as a result of the writing and reading of the test information, set a defect-free check bit (DFCB) corresponding to the defective block with reference to the recognized address thereof and append the address of the defective block to a defect information lookup table (DLT) of one of the data memories corresponding to the defective block in such a manner that it is matched with an address of a replacement block. Here, the test information is data for testing.

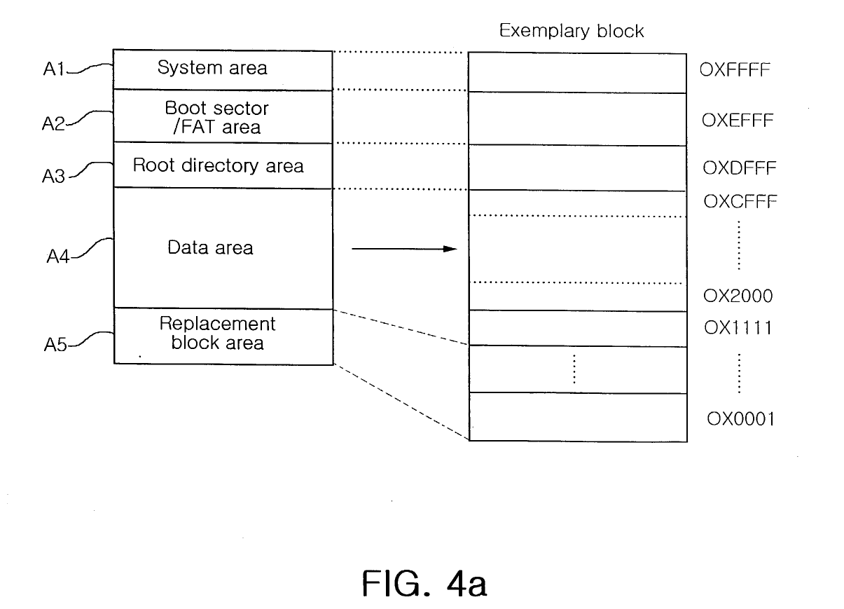

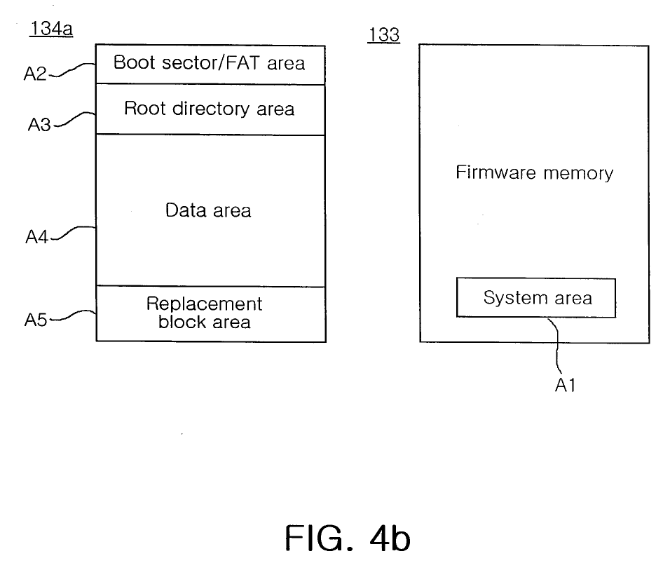

FIGS. 4a and 4b are views showing different examples of settings of storage areas of the memory card 130 in FIG. 3.

FIG. 4a shows an example of settings of storage areas of the memory card 130 in FIG. 3. In FIG. 4a, the memory card 130 includes one or more data memories 134a, each consisting of a system area A1, a boot sector/FAT area A2, a root directory area A3, a data area A4 and a replacement block area A5. Each of these areas includes one or more blocks. The system area A1 includes a defect information lookup table DLT and the replacement block area A5 includes a plurality of replacement blocks.

FIG. 4b shows another example of settings of storage areas of the memory card 130 in FIG. 3. In FIG. 4b, the memory card 130 includes one or more data memories 134a, each consisting of a boot sector/FAT area A2, a root directory area A3, a data area A4 and a replacement block area A5. Each of these areas includes one or more blocks. The replacement block area A5 includes a plurality of replacement blocks. In this case, the firmware memory 133 includes a system area A1 for storing a defect information lookup table DLT.

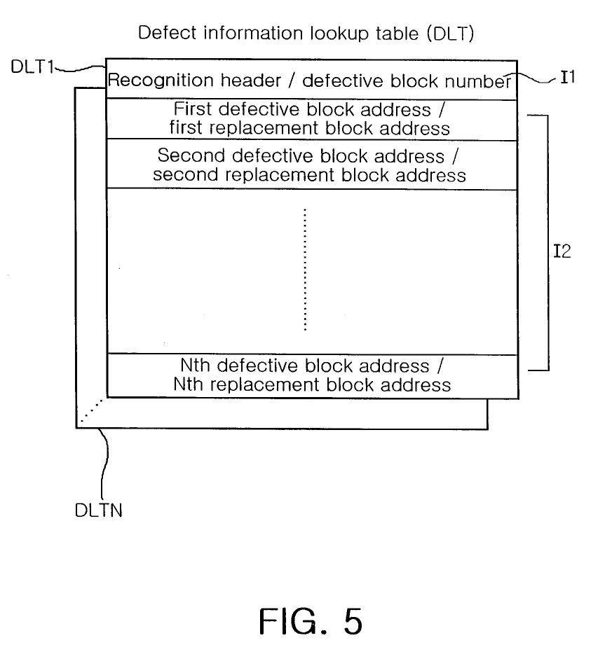

FIG. 5 is a view showing an example of the defect information lookup table DLT in FIG. 4a or 4b. The defect information lookup table DLT is any one of a plurality of defect information lookup tables DLT1-DLTN corresponding respectively to the data memories in the memory card. The defect information appended to the defect information lookup table includes recognition header/defective block number information I1 having information regarding whether a defect is present in the corresponding data memory and information regarding the number of defective blocks in the corresponding data memory, and defective block address/replacement block address information I2 having information regarding addresses of the defective blocks and information regarding addresses of replacement blocks matched respectively with the addresses of the defective blocks.

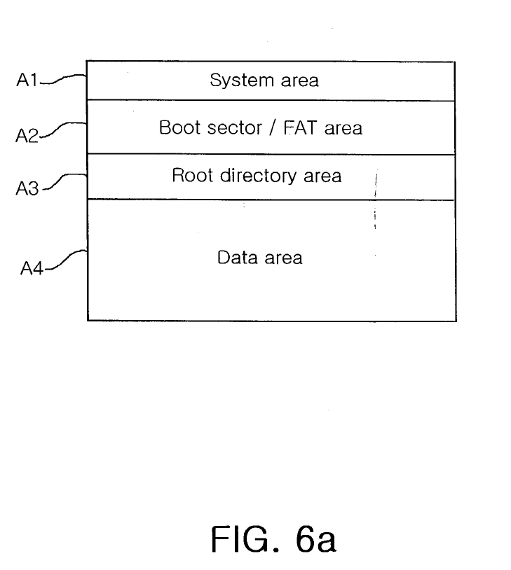

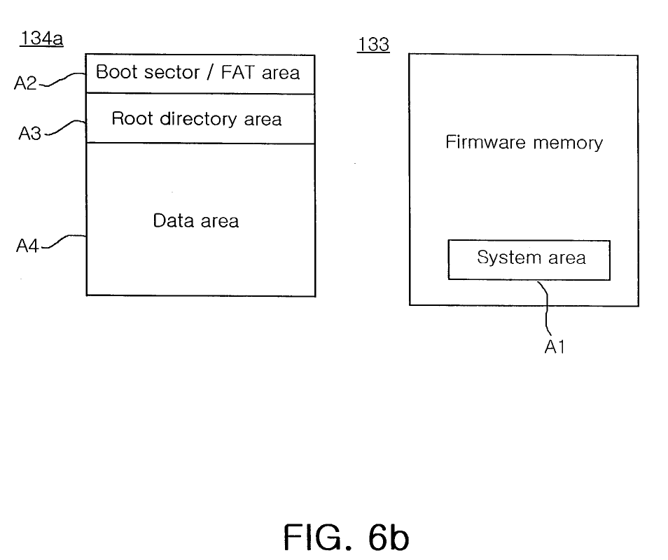

FIGS. 6a and 6b are views showing yet other examples of settings of storage areas of the memory card 130 in FIG. 3.

FIG. 6a shows another example of settings of storage areas of the memory card 130 in FIG. 3. In FIG. 6a, the memory card 130 includes one or more data memories 134a, each consisting of a system area A1, a boot sector/FAT area A2, a root directory area A3 and a data area A4. Each of these areas includes one or more blocks. The system area A1 includes a defect information lookup table DLT.

FIG. 6b shows yet another example of settings of storage areas of the memory card 130 in FIG. 3. In FIG. 6b, the memory card 130 includes one or more data memories 134a, each consisting of a boot sector/FAT area A2, a root directory area A3 and a data area A4. Each of these areas includes one or more blocks. In this case, the firmware memory 133 includes a system area A1 for storing a defect information lookup table DLT.

The memory controller 132 is adapted to perform an initialization operation upon being powered on and, for a read or write operation, determine with reference to the defect information in the defect information lookup table DLT whether an arbitrary memory block into or from which data is to be written or read is a defective block. If the arbitrary memory block is determined to be the defective block, the memory controller 132 changes an address of the arbitrary memory block to an address of a replacement block to recognize it as the address of the replacement block, and performs the read/write operation with respect to the replacement block.

Next, in order to perform the second defect-free process, the memory controller 132 can be configured in the below manner.

The memory controller 132 is configured to write and read test information into/from each of the data memories, recognize an address of a defective block as a result of the writing and reading of the test information, set a defect-free check bit corresponding to the defective block with reference to the recognized address thereof and append the address of the defective block to a defect information lookup table of one of the data memories corresponding to the defective block.

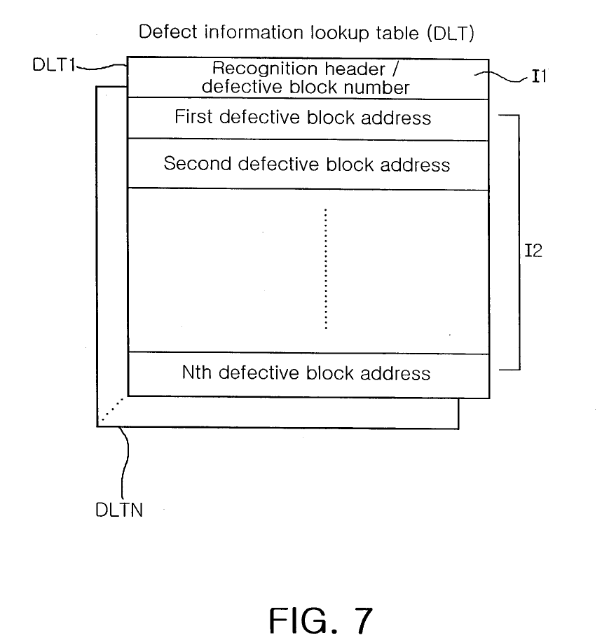

FIG. 7 is a view showing an example of the defect information lookup table in FIG. 6a or 6b. As shown in this drawing, the defect information appended to the defect information lookup table DLT includes recognition header/defective block number information I1 having information regarding whether a defect is present in the corresponding data memory and information regarding the number of defective blocks in the corresponding data memory, and defective block address information I2 having information regarding the addresses of the defective blocks.

The memory controller 132 is adapted to perform an initialization operation for each of the data memories upon being powered on and, for a read or write operation, determine with reference to the defect information in the defect information lookup table whether an arbitrary memory block into or from which data is to be written or read is a defective block. If the arbitrary memory block is determined to be the defective block, the memory controller 132 ignores an address of the arbitrary memory block, automatically changes it to and recognizes it as an address of a next block with no defect, and controls the read/write operation with respect to the next block.

As described above, according to the first embodiment of the present invention, the defect-free process is performed by the memory card 130. Alternatively, the defect-free process may be performed by the memory card driver 120 as in a second embodiment of the present invention, which will hereinafter be described in detail.

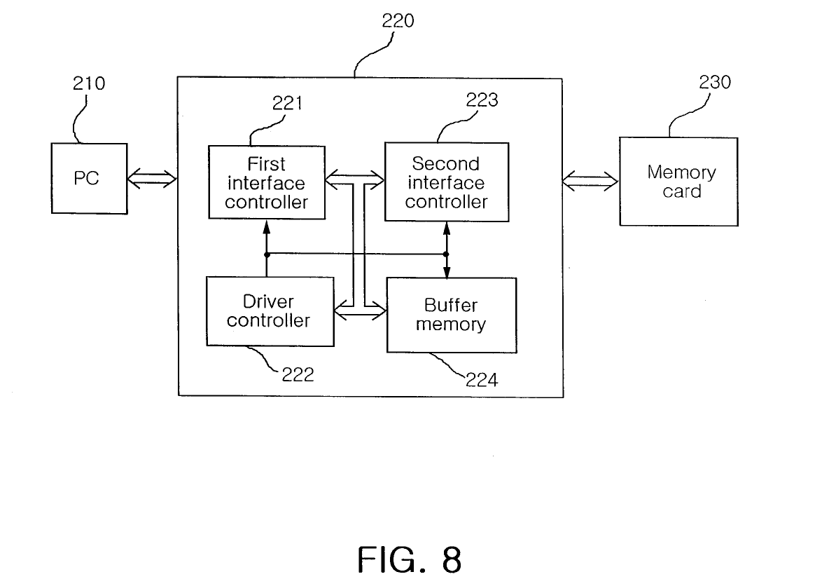

With reference to FIG. 8, there is shown in block form the construction of a memory defect processing apparatus in accordance with a second embodiment of the present invention. As shown in this drawing, the memory defect processing apparatus comprises a computer controller 210 for controlling an initial memory defect testing operation and a subsequent memory read/write operation, and a memory card driver 220 for driving one or more memories under the control of the computer controller 210. The memory card driver 220 is operated in response to a test control command from the computer controller 210, initially applied thereto, to perform the memory defect testing operation, perform a defect-free operation for a defective block if the defective block is determined to be present as a result of the memory defect testing operation, and append the resulting defect information to a defect information lookup table of one of the memories corresponding to the defective block. The memory card driver 220 is also operated in response to a read/write control command from the computer controller 210, subsequently applied thereto, to control the read/write operation for the corresponding memory with reference to the defect information of the lookup table. The memory defect processing apparatus further comprises a memory card 230 driven by the memory card driver 220. The memory card 230 includes the above memories and serves to perform the read/write operation for the corresponding memory in response to a read/write control command from the memory card driver 220.

The memory card driver 220 includes a first interface controller 221 for performing an interfacing operation with the computer controller 210, a second interface controller 223 for performing an interfacing operation with the memory card 230, and a driver controller 222 for receiving the test control command from the computer controller 210 via the first interface controller 221, performing the memory defect testing operation in response to the received test control command, performing the defect-free operation for a defective block if the defective block is determined to be present as a result of the memory defect testing operation, appending the resulting defect information to a defect information lookup table of one of the memories corresponding to the defective block, receiving the read/write control command from the computer controller 210 via the first interface controller 221 and controlling the read/write operation for the corresponding memory with reference to the defect information of the lookup table. The memory card driver 220 further includes a buffer memory 224 for storing firmware necessary to the operation of the driver controller 222 and data necessary to the control thereof.

Unlike the above-stated first and second embodiments of the present invention, a memory defect processing method according to a third embodiment of the present invention can be implemented with software, not specific hardware. This memory defect processing method may be installed in a computer to process defects in a memory unit mounted to the computer, which will hereinafter be described in detail.

Now, the operations of the respective embodiments of the present invention, constructed as stated above, will be described in detail in conjunction with the accompanying drawings.

First, a description will be given of the operation of the memory defect processing apparatus in accordance with the first embodiment of the present invention with reference to FIG. 3.

In the memory defect processing apparatus in accordance with the first embodiment of the present invention, the computer controller 110 controls an initial memory defect testing operation and a subsequent memory read/write operation. The memory card driver 120 drives one or more data memories under the control of the computer controller 110. The memory card driver 120 also controls the memory defect testing operation and memory read/write operation under the control of the computer controller 110.

The memory controller 132 in the memory card 130 is operated according to the firmware stored in the firmware memory 133. As a result, upon receiving a test control command from the computer controller 110 via the interface 131, the memory controller 132 performs the memory defect testing operation in response to the received test control command, performs the defect-free operation for a defective block if the defective block is determined to be present as a result of the memory defect testing operation, and appends the resulting defect information to a defect information lookup table of one of the data memories corresponding to the defective block. Then, in response to a read/write control command from the computer controller 110 received via the interface 131, the memory controller 132 performs the read/write operation for the corresponding data memory with reference to the defect information of the lookup table.

Here, the memory defect testing operation is carried out to test for whether a defective block is present in each of the data memories in the memory card, by writing and reading data or information for testing into/from each memory and determining whether the data or information has been normally written and read. A technique for finding a defective block through this testing operation is well known in the art and a detailed description thereof will thus be omitted in the respective embodiments of the present invention.

The memory controller 132 can perform the defect-free operation in two manners, the first being to replace a defective block with a replacement block and the second being to ignore a defective block.

First, in the first defect-free process, the memory controller 132 writes and reads test information into/from each of the data memories, recognizes an address of a defective block as a result of the writing and reading of the test information, sets a defect-free check bit DFCB corresponding to the defective block with reference to the recognized address thereof, and appends the address of the defective block to a defect information lookup table DLT of one of the data memories corresponding to the defective block in such a manner that it is matched with an address of a replacement block.

At this time, the defect information lookup table DLT can be stored in the following manner. That is, as shown in FIG. 4a, under the control of the memory controller 132, in each data memory, the system area A1 includes the defect information lookup table DLT, and the replacement block area A5 includes a plurality of replacement blocks. Alternatively, as shown in FIG. 4b, the firmware memory 133 may include the system area A1 for storing the defect information lookup table DLT.

With reference to FIG. 5 associated with FIGS. 4a and 4b, the defect information appended to the defect information lookup table DLT includes recognition header/defective block number information I1 having information regarding whether a defect is present in the corresponding data memory and information regarding the number of defective blocks in the corresponding data memory, and defective block address/replacement block address information I2 having information regarding addresses of the defective blocks and information regarding addresses of replacement blocks matched respectively with the addresses of the defective blocks. Referring to defect information of such a defect information lookup table, a determination can be made as to whether a defect is present in an arbitrary memory, and, if a defect is present, the number of defective blocks in the arbitrary memory and addresses thereof can be recognized.

After the defect-free operation is performed as stated above, the read or write operation for the corresponding data memory can be performed in the following manner. That is, the memory controller 132 performs an initialization operation upon being powered on, and then determines with reference to the defect information in the defect information lookup table whether an arbitrary memory block into or from which data is to be written or read is a defective block. If the arbitrary memory block is determined to be the defective block, the memory controller 132 changes an address of the arbitrary memory block to an address of a replacement block to recognize it as the address of the replacement block, and performs the read/write operation with respect to the replacement block.

Next, in the second defect-free process, the memory controller 132 writes and reads test information into/from each of the data memories, recognizes an address of a defective block as a result of the writing and reading of the test information, sets a defect-free check bit corresponding to the defective block with reference to the recognized address thereof, and appends the address of the defective block to a defect information lookup table of one of the data memories corresponding to the defective block.

Unlike FIGS. 4a and 4b, as shown in FIG. 6a, under the control of the memory controller 132, in each data memory, the system area A1 includes the defect information lookup table DLT. Alternatively, as shown in FIG. 6b, the firmware memory 133 may include the system area A1 for storing the defect information lookup table DLT.

With reference to FIG. 7 associated with FIGS. 6a and 6b, the defect information appended to the defect information lookup table DLT includes recognition header/defective block number information I1 having information regarding whether a defect is present in the corresponding data memory and information regarding the number of defective blocks in the corresponding data memory, and defective block address information I2 having information regarding the addresses of the defective blocks.

After the defect-free operation is performed as stated above, the read or write operation for the corresponding data memory can be performed in the following manner. That is, the memory controller 132 performs an initialization operation for each of the data memories upon being powered on, and then determines with reference to the defect information in the defect information lookup table whether an arbitrary memory block into or from which data is to be written or read is a defective block. If the arbitrary memory block is determined to be the defective block, the memory controller 132 ignores an address of the arbitrary memory block, automatically changes it to and recognizes it as an address of a next block with no defect, and controls the read/write operation with respect to the next block.

As stated previously, the defect-free processes according to the first embodiment of the present invention can be similarly applied to the second and third embodiments of the present invention which will hereinafter be described.

Next, a description will be given of the operation of the memory defect processing apparatus in accordance with the second embodiment of the present invention with reference to FIG. 8. The computer controller 210 controls an initial memory defect testing operation and a subsequent memory read/write operation by means of the memory card driver 220.

The memory card driver 220 drives the memory card 230 under the control of the computer controller 210. In response to a test control command from the computer controller 210, the memory card driver 220 performs the memory defect testing operation for the memory card 230, performs a defect-free operation for a defective block if the defective block is determined to be present as a result of the memory defect testing operation, and appends the resulting defect information to a defect information lookup table of one of one or more memories in the memory card 230 corresponding to the defective block. Then, in response to a read/write control command from the computer controller 210, the memory card driver 220 controls the read/write operation for the corresponding memory in the memory card 230 with reference to the defect information of the lookup table.

The memory card 230 is driven by the memory card driver 220. In response to a read/write control command from the memory card driver 220, the memory card 230 performs the read/write operation for the corresponding memory therein.

In detail, in the memory card driver 220, the driver controller 222 is operated according to the firmware stored in the buffer memory 224. As a result, upon receiving the test control command from the computer controller 210 via the first interface controller 221, the driver controller 222 performs the memory defect testing operation in response to the received test control command, performs the defect-free operation for a defective block if the defective block is determined to be present as a result of the memory defect testing operation, and appends the resulting defect information to a defect information lookup table of one of the memories corresponding to the defective block. Then, in response to the read/write control command from the computer controller 210 received via the first interface controller 221, the driver controller 222 controls the read/write operation for the corresponding memory with reference to the defect information of the lookup table. Further, the driver controller 222 stores data necessary to its control in the buffer memory 224.

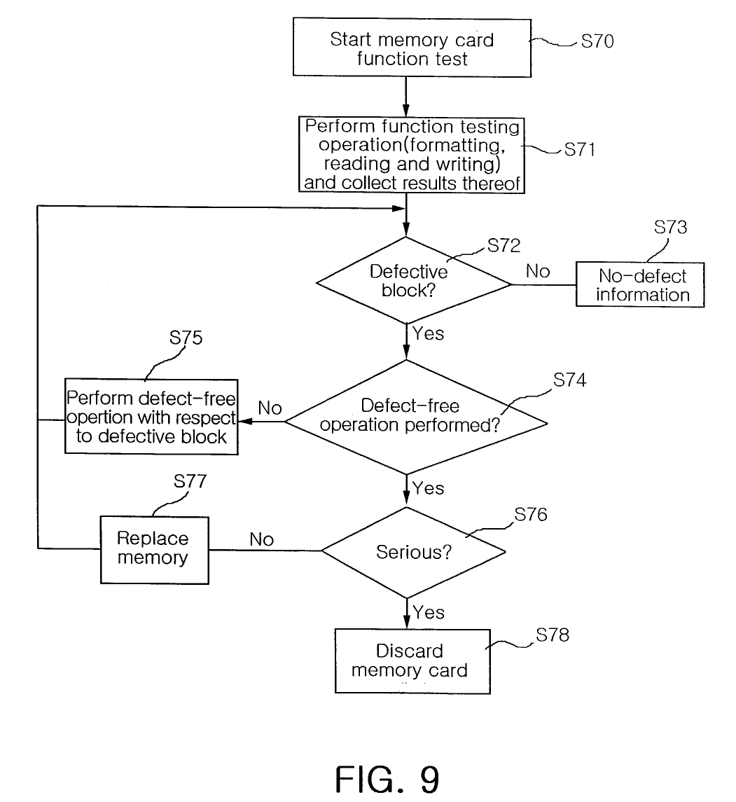

FIG. 9 is a flow chart illustrating the memory defect processing method in accordance with the third embodiment of the present invention. A description will hereinafter be given of the memory defect processing method in accordance with the third embodiment of the present invention with reference to FIG. 9.

At the first step (S70 and S71), a memory function testing operation is performed and the results thereof are collected. Namely, a formatting operation and read/write operation are performed with respect to one or more memories and the results thereof are collected.

At the second step (S72 and S73), if no defect is determined to be present in the memories on the basis of the collected results, no-defect information is provided. However, if a defect is determined to be present, the method proceeds to a subsequent step.

At the above first step, block address information corresponding to each of the memories and result information corresponding to each block in each memory, namely, format enable or disable information, read enable or disable information, write enable or disable information, etc. are collected.

Next, at the third step S74, if a defect is determined to be present at the above second step, a determination is made as to whether a defect-free operation has been performed with respect to a defective block having the defect. This determination is made with reference to a defect free check bit DFCB which will be described later.

At the fourth step S75, in the case where it is determined at the above third step S74 that the defect-free operation has not been performed, the defect-free operation is performed with respect to the defective block. Namely, an address of the defective block is recognized when the defective block is found during the function testing operation such as reading and writing. The address of the defective block is then stored in a defect information lookup table DLT of a specific one of the memories having the defective block upon completion of the function testing operation.

Subsequently, at the fifth step (S76 and S77), in the case where it is determined at the above third step S74 that the defect-free operation has been performed, a determination is made as to whether the defect is serious. If the defect is determined not to be serious, information for replacement of the specific memory having the defective block is provided. At the sixth step S78, if the defect is determined to be serious at the above fifth step, information for discarding of a memory card including the memories is provided.

The defect-free operation includes two processes, the first being to replace a defective block with a replacement block or the second being to ignore a defective block.

First, the first defect-free process will be described.

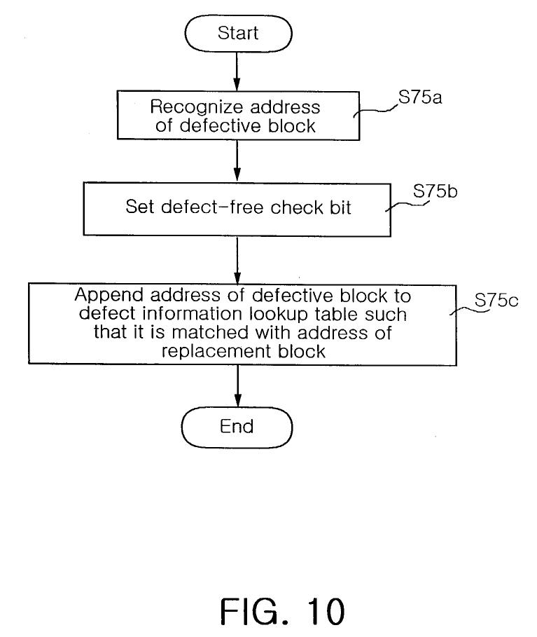

FIG. 10 is a flow chart illustrating an example of the defect-free process in FIG. 9. Referring to FIG. 10, at the first sub-step S75a of the fourth step S75, test information is written and read into/from each of the memories and the address of the defective block is recognized as a result of the writing and reading of the test information. At the second sub-step S75b, a defect-free check bit DFCB corresponding to the defective block is set with reference to the address of the defective block. At the third sub-step S75c, the address of the defective block is appended to the defect information lookup table DLT in such a manner that it is matched with an address of a replacement block.

The defect information lookup table (DLT) is any one of a plurality of defect information lookup tables DLT1-DLTN corresponding respectively to the memories in the memory card. The defect information appended to the defect information lookup table includes recognition header/defective block number information I1 having information regarding whether a defect is present in the specific memory and information regarding the number of defective blocks in the specific memory, and defective block address/replacement block address information I2 having information regarding addresses of the defective blocks and information regarding addresses of replacement blocks matched respectively with the addresses of the defective blocks.

Referring to recognition header/defective block number information I1 of such a defect information lookup table DLT, a determination can be made as to whether a defect is present in an arbitrary memory, and the number of defective blocks in the arbitrary memory can be recognized if a defect is present. Also, referring to defective block address/replacement block address information I2 of such a defect information lookup table DLT, an address of a defective block can be changed to and recognized as an address of a replacement block.

After a defective block is matched with a replacement block through the above process, a read/write operation can be performed with respect to a specific memory having the defective block by referring to a defect information lookup table DLT including defect information corresponding to the specific memory, as follows.

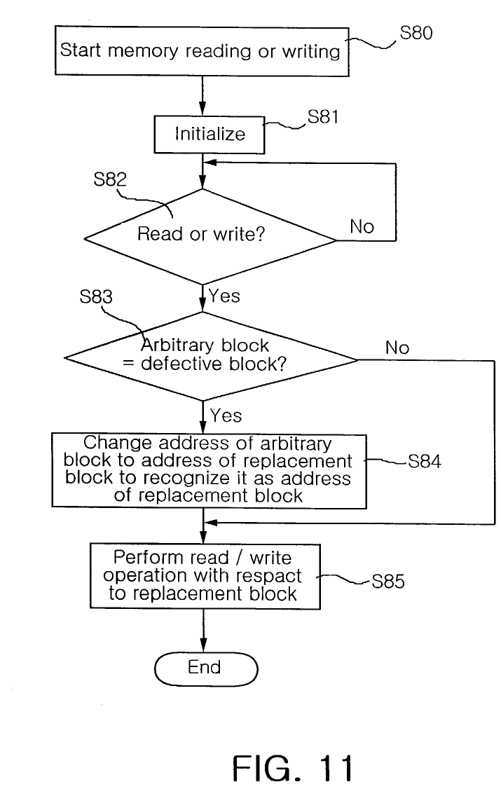

FIG. 11 is a flow chart illustrating a memory read/write method corresponding to the defect-free process of FIG. 10. Referring to FIG. 11, at the seventh step (S80 and S81), an initialization operation is performed with respect to each memory upon being powered on. Thereafter, at the eighth step (S82 and S83), for a read or write operation, a determination is made with reference to the defect information in the defect information lookup table as to whether an arbitrary memory block into or from which data is to be written or read is a defective block. At the ninth step S84, if the arbitrary memory block is determined to be the defective block at the above eighth step, an address of the arbitrary memory block is changed to and recognized as an address of a replacement block. Then, at the tenth step S85, the read/write operation is performed with respect to the replacement block.

Next, the second defect-free process will be described.

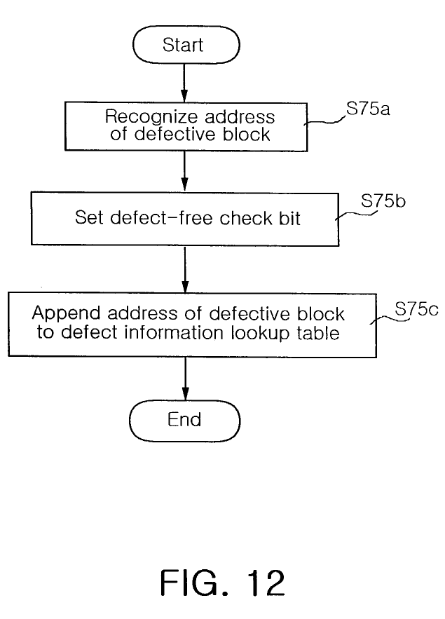

FIG. 12 is a flow chart illustrating another example of the defect-free process in FIG. 9. Referring to FIG. 12, at the first sub-step S75a of the fourth step S75, test information is written and read into/from each of the memories and the address of the defective block is recognized as a result of the writing and reading of the test information. At the second sub-step S75b, a defect-free check bit DFCB corresponding to the defective block is set with reference to the address of the defective block. At the third sub-step S75c, the address of the defective block is appended to the defect information lookup table DLT.

The defect information appended to the defect information lookup table DLT includes recognition header/defective block number information I1 having information regarding whether a defect is present in the specific memory and information regarding the number of defective blocks in the specific memory, and defective block address information I2 having information regarding the addresses of the defective blocks.

Referring to recognition header/defective block number information I1 of such a defect information lookup table DLT, a determination can be made as to whether a defect is present in an arbitrary memory, and the number of defective blocks in the arbitrary memory can be recognized if a defect is present. Also, an address of a defective block can be recognized with reference to defective block address information I2 of such a defect information lookup table DLT.

After an address of a defective block is recognized through the above process, a read/write operation can be performed with respect to a specific memory having the defective block by referring to a defect information lookup table DLT including defect information corresponding to the specific memory, as follows.

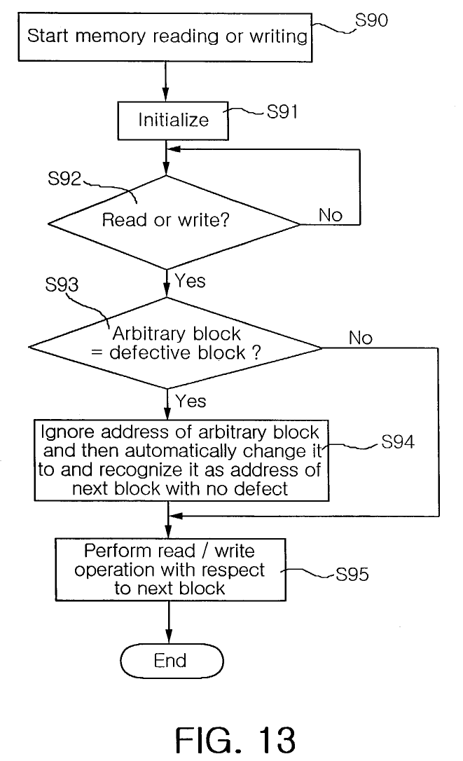

FIG. 13 is a flow chart illustrating a memory read/write method corresponding to the defect-free process of FIG. 12. Referring to FIG. 13, at the seventh step (S90 and S91), an initialization operation is performed with respect to each memory upon being powered on. Thereafter, at the eighth step (S92 and S93), for a read or write operation, a determination is made with reference to the defect information in the defect information lookup table as to whether an arbitrary memory block into or from which data is to be written or read is a defective block. At the ninth step S94, if the arbitrary memory block is determined to be the defective block at the above eighth step, an address of the arbitrary memory block is ignored, and then automatically changed to and recognized as an address of a next block with no defect. Then, at the tenth step S95, the read/write operation is performed with respect to the next block.

As apparent from the above description, the present invention provides an apparatus and method for processing defects in a card-type memory unit such as a flash memory card, which can detect a defective location of the memory unit and replace a memory area having the detected defective location with a different memory area, or ignore it, so that the memory unit can be used regardless of defects.

Therefore, actual yield can be increased in a production process, and purchasing costs of additional memory cards can be reduced when the memory unit is in use, resulting in reduced frequency of breakdowns and reduced maintenance costs.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. An apparatus for processing defects in one or more memories, comprising:
a computer controller for controlling an initial memory defect testing operation and a subsequent memory read/write operation;
a memory card driver for driving said memories under the control of said computer controller and controlling said memory defect testing operation and memory read/write operation under the control of said computer controller; and
a memory card responsive to a test control command from said computer controller, initially applied thereto via said memory card driver, for performing said memory defect testing operation, performing a defect-free operation for a defective block if the defective block is determined to be present as a result of said memory defect testing operation and appending the resulting defect information to a defect information lookup table of one of said memories corresponding to said defective block, and responsive to a read/write control command from said computer controller, subsequently applied thereto via said memory card driver, for performing said read/write operation for said corresponding memory with reference to said defect information of said lookup table.

2. The apparatus as set forth in claim 1, wherein said memory card includes:
an interface connected to said memory card driver;
a memory controller for receiving said test control command from said computer controller via said interface, performing said memory defect testing operation in response to the received test control command, performing said defect-free operation for said defective block if said defective block is determined to be present as a result of said memory defect testing operation, appending the resulting defect information to said defect information lookup table of said memory corresponding to said defective block, receiving said read/write control command from said computer controller via said interface and controlling said read/write operation for said corresponding memory with reference to said defect information of said lookup table;
said memories, said memories being one or more data memories for storing data under the control of said memory controller; and
a firmware memory for storing firmware necessary to the operation of said memory controller.

3. The apparatus as set forth in claim 2, wherein said memory controller is adapted to, when performing said memory defect testing operation, write and read test information into/from each of said data memories, recognize an address of said defective block as a result of the writing and reading of the test information, set a defect-free check bit corresponding to said defective block with reference to the recognized address thereof and append said address of said defective block to said defect information lookup table in such a manner that it is matched with an address of a replacement block.

4. The apparatus as set forth in claim 3, wherein said defect information appended to said defect information lookup table includes:
recognition header/defective block number information having information regarding whether a defect is present in said corresponding data memory and information regarding the number of defective blocks in said corresponding data memory; and
defective block address/replacement block address information having information regarding addresses of the defective blocks and information regarding addresses of replacement blocks matched respectively with the addresses of the defective blocks.

5. The apparatus as set forth in claim 3, wherein said memory controller is adapted to perform an initialization operation upon being powered on, determine with reference to said defect information in said defect information lookup table whether an arbitrary block in said corresponding data memory into or from which data is to be written or read is a defective block when performing said read or write operation, changing an address of the arbitrary memory block to an address of a replacement block to recognize it as the address of the replacement block if the arbitrary memory block is determined to be the defective block, and performing said read/write operation with respect to the replacement block.

6. The apparatus as set forth in claim 2, wherein said memory controller is adapted to, when performing said memory defect testing operation, write and read test information into/from each of said data memories, recognize an address of said defective block as a result of the writing and reading of the test information, set a defect-free check bit corresponding to said defective block with reference to the recognized address thereof and append said address of said defective block to said defect information lookup table.

7. The apparatus as set forth in claim 6, wherein said defect information appended to said defect information lookup table includes:
recognition header/defective block number information having information regarding whether a defect is present in said corresponding data memory and information regarding the number of defective blocks in said corresponding data memory; and
defective block address information having information regarding the addresses of the defective blocks.

8. The apparatus as set forth in claim 6, wherein said memory controller is adapted to perform an initialization operation for each of said data memories upon being powered on, determine with reference to said defect information in said defect information lookup table whether an arbitrary block in said corresponding data memory into or from which data is to be written or read is a defective block when performing said read or write operation, ignore an address of the arbitrary memory block if the arbitrary memory block is determined to be the defective block, automatically change the address of the arbitrary memory block to an address of a next block with no defect to recognize it as the address of the next block, and control said read/write operation with respect to the next block.

9. An apparatus for processing defects in one or more memories, comprising:
a computer controller for controlling an initial memory defect testing operation and a subsequent memory read/write operation;
a memory card driver for driving said memories under the control of said computer controller, said memory card driver being operated in response to a test control command from said computer controller, initially applied thereto, to perform said memory defect testing operation, perform a defect-free operation for a defective block if the defective block is determined to be present as a result of said memory defect testing operation and append the resulting defect information to a defect information lookup table of one of said memories corresponding to said defective block, and operated in response to a read/write control command from said computer controller, subsequently applied thereto, to control said read/write operation for said corresponding memory with reference to said defect information of said lookup table; and
a memory card driven by said memory card driver, said memory card including said memories and serving to perform said read/write operation for said corresponding memory in response to a read/write control command from said memory card driver.

10. The apparatus as set forth in claim 9, wherein said memory card driver includes:
a first interface controller for performing an interfacing operation with said computer controller;
a second interface controller for performing an interfacing operation with said memory card;
a driver controller for receiving said test control command from said computer controller via said first interface controller, performing said memory defect testing operation in response to the received test control command, performing said defect-free operation for said defective block if said defective block is determined to be present as a result of said memory defect testing operation, appending the resulting defect information to said defect information lookup table of said memory corresponding to said defective block, receiving said read/write control command from said computer controller via said first interface controller and controlling said read/write operation for said corresponding memory with reference to said defect information of said lookup table; and
a buffer memory for storing firmware necessary to the operation of said driver controller and data necessary to the control thereof.

11. The apparatus as set forth in claim 10, wherein said driver controller is adapted to, when performing said memory defect testing operation, write and read test information into/from each of said memories, recognize an address of said defective block as a result of the writing and reading of the test information, set a defect-free check bit corresponding to said defective block with reference to the recognized address thereof and append said address of said defective block to said defect information lookup table in such a manner that it is matched with an address of a replacement block.

12. The apparatus as set forth in claim 11, wherein said defect information appended to said defect information lookup table includes:
recognition header/defective block number information having information regarding whether a defect is present in said corresponding memory and information regarding the number of defective blocks in said corresponding memory; and
defective block address/replacement block address information having information regarding addresses of the defective blocks and information regarding addresses of replacement blocks matched respectively with the addresses of the defective blocks.

13. The apparatus as set forth in claim 11, wherein said driver controller is adapted to perform an initialization operation upon being powered on, determine with reference to said defect information in said defect information lookup table whether an arbitrary block in said corresponding memory into or from which data is to be written or read is a defective block when performing said read or write operation, changing an address of the arbitrary memory block to an address of a replacement block to recognize it as the address of the replacement block if the arbitrary memory block is determined to be the defective block, and performing said read/write operation with respect to the replacement block.

14. The apparatus as set forth in claim 10, wherein said driver controller is adapted to, when performing said memory defect testing operation, write and read test information into/from each of said memories, recognize an address of said defective block as a result of the writing and reading of the test information, set a defect-free check bit corresponding to said defective block with reference to the recognized address thereof and append said address of said defective block to said defect information lookup table.

15. The apparatus as set forth in claim 14, wherein said defect information appended to said defect information lookup table includes:
recognition header/defective block number information having information regarding whether a defect is present in said corresponding memory and information regarding the number of defective blocks in said corresponding memory; and
defective block address information having information regarding the addresses of the defective blocks.

16. The apparatus as set forth in claim 14, wherein said driver controller is adapted to perform an initialization operation for each of said memories upon being powered on, determine with reference to said defect information in said defect information lookup table whether an arbitrary block in said corresponding memory into or from which data is to be written or read is a defective block when performing said read or write operation, ignore an address of the arbitrary memory block if the arbitrary memory block is determined to be the defective block, automatically change the address of the arbitrary memory block to an address of a next block with no defect to recognize it as the address of the next block, and control said read/write operation with respect to the next block.

17. A method for processing defects in one or more memories, comprising the steps of:
a) performing a memory function testing operation and collecting results thereof;
b) providing no-defect information if no defect is determined to be present in said memories on the basis of the collected results, and proceeding to a subsequent step if a defect is determined to be present;
c) determining whether a defect-free operation has been performed with respect to a defective block having a defect, if the defect is determined to be present at said step b);
d) performing said defect-free operation with respect to said defective block if it is determined at said step c) that said defect-free operation has not been performed;
e) determining whether the defect is serious, if it is determined at said step c) that said defect-free operation has been performed, and providing information for replacement of a specific one of said memories having said defective block if the defect is determined not to be serious; and
f) providing information for discarding of a memory card including said memories if the defect is determined to be serious at said step e).

18. The method as set forth in claim 17, wherein said step d) includes the steps of:
d-1) writing and reading test information into/from each of said memories and recognizing an address of said defective block as a result of the writing and reading of the test information;
d-2) setting a defect-free check bit corresponding to said defective block with reference to said address of said defective block; and
d-3) appending said address of said defective block to a defect information lookup table of said specific memory having said defective block in such a manner that it is matched with an address of a replacement block.

19. The method as set forth in claim 18, wherein said defect information appended to said defect information lookup table at said step d) includes:
recognition header/defective block number information having information regarding whether a defect is present in said specific memory and information regarding the number of defective blocks in said specific memory; and
defective block address/replacement block address information having information regarding addresses of the defective blocks and information regarding addresses of replacement blocks matched respectively with the addresses of the defective blocks.

20. The method as set forth in claim 19, further comprising the steps of:
g) performing an initialization operation with respect to each of said memories upon being powered on;
h) determining with reference to said defect information in said defect information lookup table whether an arbitrary block in said specific memory into or from which data is to be written or read is a defective block when performing a read or write operation;
i) changing an address of the arbitrary memory block to an address of a replacement block to recognize it as the address of the replacement block if the arbitrary memory block is determined to be the defective block at said step h); and
j) performing said read/write operation with respect to the replacement block.

21. The method as set forth in claim 17, wherein said step d) includes the steps of:
d-1) writing and reading test information into/from each of said memories and recognizing an address of said defective block as a result of the writing and reading of the test information;
d-2) setting a defect-free check bit corresponding to said defective block with reference to said address of said defective block; and
d-3) appending said address of said defective block to a defect information lookup table of said specific memory having said defective block.

22. The method as set forth in claim 21, wherein said defect information appended to said defect information lookup table at said step d) includes:
recognition header/defective block number information having information regarding whether a defect is present in said specific memory and information regarding the number of defective blocks in said specific memory; and
defective block address information having information regarding the addresses of the defective blocks.

23. The method as set forth in claim 22, further comprising the steps of:
g) performing an initialization operation with respect to each of said memories upon being powered on;
h) determining with reference to said defect information in said defect information lookup table whether an arbitrary block in said specific memory into or from which data is to be written or read is a defective block when performing a read or write operation;
i) ignoring an address of the arbitrary memory block if the arbitrary memory block is determined to be the defective block at said step h), and then automatically changing the address of the arbitrary memory block to an address of a next block with no defect to recognize it as the address of the next block; and
j) performing said read/write operation with respect to the next block.
